(19) United States
(12) Patent Application Publication
(10) Pub. No.: US 2010/0005235 A1
(43) Pub. Date: Jan. 7, 2010

(54) COMPUTER SYSTEM

(75) Inventor: PENG-ZHENG YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/327,907

(22) Filed: Dec. 4, 2008

(30) Foreign Application Priority Data
Jul. 3, 2008 (CN) 200810302518.5

(51) Int. Cl. G06F 12/06

(52) U.S. Cl. 711/105; 711/E12.083

(57) ABSTRACT

A computer system includes a CPU and a system on chip (SoC) processor electronically connected with the CPU in the computer system. The CPU and the SoC processor do not work simultaneously. The CPU processes work and a service when the computer system is powered on. The SoC processor continues processing the work and the service that are unfinished after the computer system is shut down.

### BACKGROUND

1. Technical Field

The present disclosure relates to a computer system with a system on chip.

2. Description of Related Art

There may be times when computer users are using their computers for only a small number of tasks. For example, the users may leave their computers on overnight to download a large file. Since the computer is in a state of readiness for use of any of its other functions, more power is being consumed than needed, which is wasteful.

Therefore, a computer system, which could be powered down except for only what is necessary to complete a small number of tasks is desired to overcome the above-described shortcomings.

### BRIEF DESCRIPTION OF THE DRAWINGS

FIG. 1 is a configuration view of an embodiment of a computer system; and

FIG. 2 is a flow chart of the embodiment of the computer system.

### DETAILED DESCRIPTION OF THE EMBODIMENTS

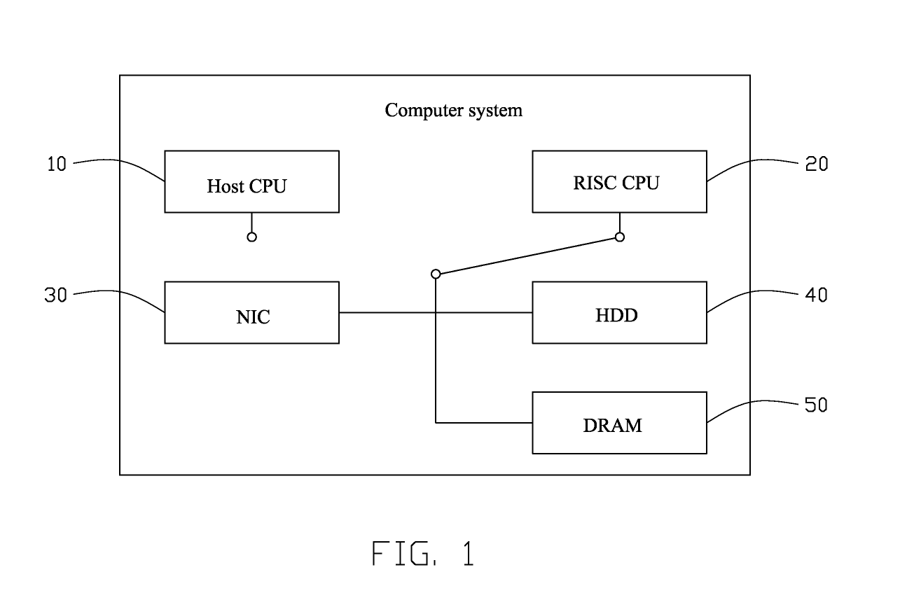

Referring to FIG. 1, a computer system includes a host central processing unit (CPU) 10, a reduced instruction set computing (RISC) CPU 20, such as a system on chip processor, a network interface card (NIC) 30, a hard disk drive (HDD) 40, and a dynamic random access memory (DRAM) 50. The RISC CPU 20 operates after the host CPU 10 is shut down in order to replace the host CPU 10 to complete one or more tasks and services that do not require all the resources supplied by the host CPU 10. Such tasks may include for example, downloads, uploads, video, point-to-point resume, and so on. Such services may include a printer service, media service, samba, network file system (NFS), and so on. The host CPU 10 sets all environmental and user settings in the HDD 40, so the RISC CPU 20 may use the same settings. Thus, the RISC CPU 20 has reached a zero setting meaning that the RISC CPU does not need to set all environmental and user settings again, and the RISC CPU can only use the same settings as the host CPU. The one or more services that users may need, can be continued when the host CPU 10 is shut down because the RISC CPU 20 takes over for the host CPU 10, thus saving power by only using that which is needed to complete the specific task or tasks.

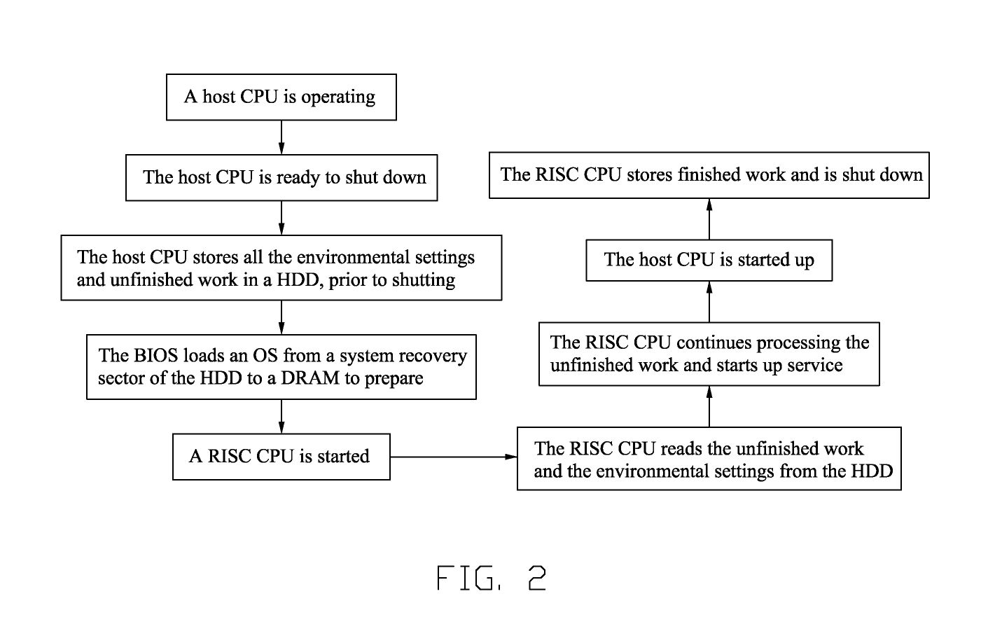

Referring also to FIG. 2, a flow chart of the computer system is disclosed. At first, the host CPU 10 is operating. When the host CPU 10 is ready to shut down on command from a user, the host CPU 10 stores information of any unfinished work and services in the HDD 40, prior to shutting down. During this time, the basic input-output system (BIOS) of the computer system loads an operating system (OS) from a system recovery sector of the HDD 40 to the DRAM 50 to prepare for the RISC CPU 20 to start up. The RISC CPU 20 is started and loads the OS into the DRAM 50. The RISC CPU 20 reads the environmental settings, such as network IP, and the assigned tasks, such as an unfinished portion of a point to point file transfer, from the HDD 40. The RISC CPU 20 then takes over the tasks until the tasks are completed or the host CPU 10 is started again. The users can modify the BIOS of the computer system to decide a shutdown time of the RISC CPU 20. The RISC CPU 20 may be shut down before the BIOS of the computer system reads a HDD type of the HDD 40, or loads a boot partition.

The RISC CPU 20 uses enough power to perform designated tasks, whereas the host CPU 10 consumes more power for functions in use and to stay in a state of readiness for those functions not in use. In addition, the RISC CPU 20 is secure and efficient with the OS. The OS of the RISC CPU 20 is loaded into the DRAM 50 from the system recovery sector of the HDD 40 by the BIOS of the computer system. The RISC CPU 20 needs no additional flash, so costs are minimized.

When the computer system is shut down, there is, for example, only a +5 Volt power supply needed for the RISC CPU 20. The +5 Volt power may also supply power to the NIC 30 and a keyboard in the computer system.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A computer system, comprising:
a hard disk drive (HDD);
a host central processing unit (CPU) configured to store an environmental setting and unfinished work; and
a reduced instruction set computing (RISC) CPU configured to read the stored environmental setting and the unfinished work from the HDD to continue working after the host CPU is shut down.

2. The computer system of claim 1, further comprising a DRAM, wherein an OS of the RISC CPU is loaded into the DRAM from a system recovery sector of the HDD by the basic input-output system (BIOS) of the computer system so that the RISC CPU powers on.

3. The computer system of claim 1, wherein a +5 Volt power is supplied to the RISC CPU after the host CPU is shut down.

4. The computer system of claim 1, wherein the unfinished work comprises downloads, uploads, video, and point-to-point resuming.

5. The computer system of claim 1, wherein the RISC CPU replaces the host CPU to start up a service.

6. The computer system of claim 5, wherein the service comprises printer server, media server, samba, and network file system (NFS).

7. A computer system, comprising:
a CPU; and
a system on chip (SoC) processor electronically connected with the CPU in the computer system;
wherein the CPU and the SoC processor do not work simultaneously; the CPU processes work and a service when the computer system is powered on, and the SoC processor continues processing the work and the service that are unfinished by the CPU after the computer system is shut down.

8. The computer system of claim 7, wherein the CPU stores the unfinished work and the service in a HDD, and the SoC processor reads the stored work and service from the HDD.

9. The computer system of claim 8, further comprising a DRAM, an OS of the SoC processor is loaded into the DRAM from a system recovery sector of the HDD by a BIOS of the computer system so that the SoC processor can be started up.

10. The computer system of claim 7, wherein a +5 Volt power is supplied to the SoC processor after the CPU is shut down.

11. The computer system of claim 7, wherein the unfinished work comprises downloads, uploads, video, and point-to-point resuming.

12. The computer system of claim 7, wherein the service comprises printer server, media server, samba, and network file system (NFS).

13. The computer system of claim 7, wherein the SoC processor is a RISC CPU.
